(19) United States
(12) Patent Application Publication
(10) Pub. No.: US 2016/0176721 A1
(43) Pub. Date: Jun. 23, 2016

(54) METHODS OF PRODUCING ALKALI METAL CARBONATES, AND SYSTEMS FOR PRACTICING THE SAME

(71) Applicant: Blue Planet, Ltd., Los Gatos, CA (US)

(72) Inventors: Mark Bewernitz, Los Gatos, CA (US); Brent R. Constantz, Portola Valley, CA (US)

(21) Appl. No.: 14/792,418

(22) Filed: Jul. 6, 2015

Related U.S. Application Data
(60) Provisional application No. 62/024,394, filed on Jul. 14, 2014.

(51) Int. Cl. C01D 7/12; B01J 19/24

(52) U.S. Cl. CPC C01D 7/12; B01J 19/24; B01J 2219/24

(57) ABSTRACT

Methods of producing an alkali metal carbonates are provided. Aspects of the methods include concentrating a bicarbonate containing aqueous medium to generate a bicarbonate rich product and then combining the concentrated bicarbonate rich product with an alkali metal ion source, optionally in the presence of a source of CO₂, under conditions sufficient to product an alkali metal carbonate, e.g., sodium carbonate or sodium bicarbonate. Also provided herein are systems that find use in practicing the subject methods.

### CROSS-REFERENCE TO RELATED APPLICATION

Pursuant to 35 U.S.C. §119(e), this application claims priority to the filing date of U.S. Provisional Application Ser. No. 62/024,394 filed on Jul. 14, 2014; the disclosure of which application is herein incorporated by reference.

### INTRODUCTION

Sodium salts of carbonic acid include sodium bicarbonate and sodium carbonate. Sodium carbonate (also known as soda ash) has the chemical formula Na₂CO₃, and is a white crystalline solid. Sodium carbonate finds use, for example, in glass and paper manufacturing, in the production of sodium bicarbonate, as a water-softening agent and as a cleaning agent.

Sodium carbonate is traditionally made from trona ore mined from soda ash-rich deposits, or via the Solvay process. Mined trona is processed by two main methods to produce sodium carbonate: the sesquicarbonate process and the monohydrate process. In the sesquicarbonate process, trona ore is dissolved to produce a solution from which sodium sesquicarbonate can be crystallized. Calcining the sodium sesquicarbonate crystals produces soda ash. In the monohydrate process, mined trona ore is calcined, dissolved in water to produce a solution from which sodium carbonate monohydrate is crystallized. Calcining the sodium carbonate monohydrate crystals produces soda ash. In the Solvay process, a concentrated sodium chloride solution is reacted with ammonia gas to produce an ammonia-buffered brine. In a separate reaction, limestone (calcium carbonate) is calcined to produce carbon dioxide (CO₂) gas, which is then passed through the ammonia-buffered brine to cause sodium bicarbonate to precipitate out. Calcination of the sodium bicarbonate produces sodium carbonate.

Sodium bicarbonate (also known as sodium hydrogen carbonate and baking soda) has the chemical formula NaHCO₃, and is a white crystalline solid. Sodium bicarbonate finds use in many industrial and domestic applications. It is used as a source of gas, for example, as a leavening agent in food preparation, as a foaming agent for plastics and rubber and as a source of carbon dioxide in fire extinguishers. Sodium bicarbonate is also used as a cleaning agent, as a biopesticide, and as a buffering agent to treat indigestion and acidosis.

Traditional methods of producing sodium bicarbonate include mining of trona ore and processing the mined trona to obtain soda ash (sodium carbonate). Dissolved soda ash is carbonated with exposure to carbon dioxide (CO₂) gas, which causes precipitation of sodium bicarbonate.

### SUMMARY

Methods of producing alkali metal carbonates are provided. Aspects of the methods include, concentrating a bicarbonate containing aqueous medium to generate a bicarbonate rich product and contacting the resultant bicarbonate rich product with an alkali metal ion source and/or a carbon dioxide containing gas under conditions sufficient to produce an alkali metal carbonate, e.g., sodium carbonate or sodium bicarbonate. Also provided are systems for use in practicing the methods.

### BRIEF DESCRIPTION OF THE FIGURES

FIGS. 1A and 1B provide an overview of an alkali metal carbonate production process according to embodiments of the invention.

FIG. 2 provides a representation of a liquid condensed phase that may be present in a bicarbonate containing aqueous medium employed in the methods of the invention.

FIGS. 3A and 3B provide schematic depictions of systems for producing an alkali metal carbonate according to embodiments of the invention.

FIG. 4 provides a schematic depiction of a system for producing an alkali metal carbonate according to embodiments of the invention, operationally coupled to a reactor for producing a bicarbonate containing aqueous medium.

### DETAILED DESCRIPTION

Methods of producing an alkali metal carbonate are provided. Aspects of the methods include concentrating a bicarbonate containing aqueous medium to generate a bicarbonate rich product and contacting the bicarbonate rich product with an alkali metal ion source and/or a carbon dioxide (CO₂) containing gas under conditions sufficient to produce an alkali metal carbonate, e.g., sodium carbonate or sodium bicarbonate. Also provided are systems that find use in practicing the subject methods.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a,” “an” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Methods

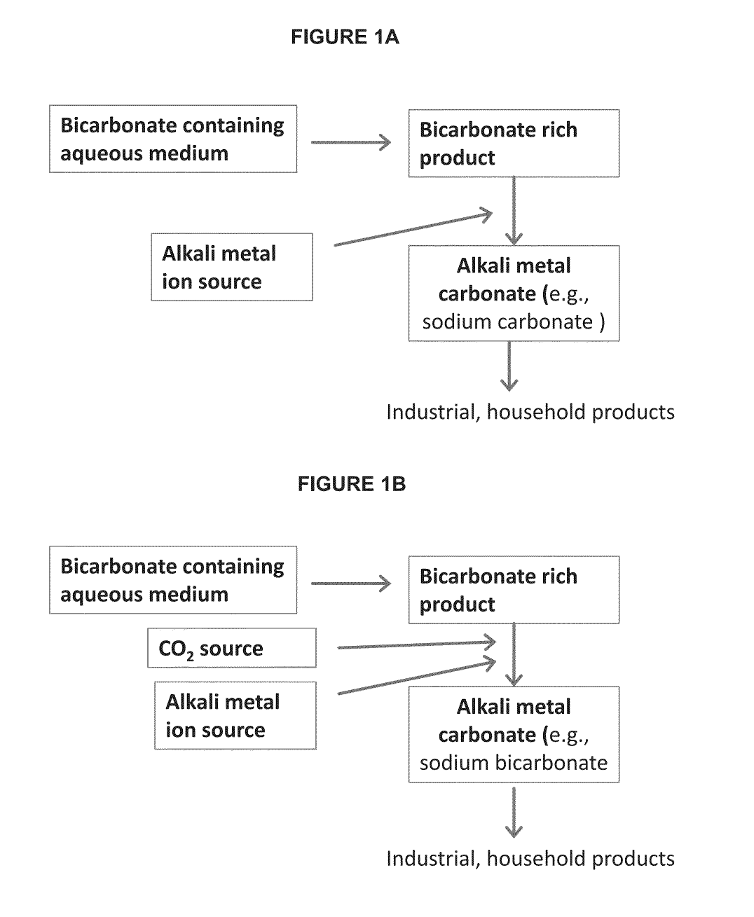

Aspects of the invention are directed to methods of producing an alkali metal carbonate, i.e., an alkali metal salt of carbonic acid, from a bicarbonate containing aqueous medium. As shown in FIG. 1A, a bicarbonate containing aqueous medium is concentrated and the resultant bicarbonate rich product is contacted with an alkali metal ion source under conditions sufficient to produce an alkali metal carbonate, in an embodiment of the invention. In another embodiment of the invention, shown in FIG. 1B, a bicarbonate containing aqueous medium is concentrated to generate a bicarbonate rich product, which is then contacted with a carbon dioxide (CO₂) containing gas and an alkali metal ion source to produce an alkali metal carbonate salt, e.g., sodium carbonate salt. In certain embodiments, the alkali metal carbonate is an alkali metal bicarbonate salt, e.g., sodium bicarbonate. The various aspects of the methods of the invention are now described in greater detail below.

### Bicarbonate Containing Aqueous Medium

As summarized above, aspects of the methods include concentrating a bicarbonate containing aqueous medium to generate a bicarbonate rich product. According to aspects of the present methods, a bicarbonate containing aqueous medium and a bicarbonate rich product may each contain amounts of bicarbonate ion in an aqueous medium, where the concentration of bicarbonate ion in the bicarbonate rich product is higher than the concentration of bicarbonate ion in the bicarbonate containing aqueous medium, as will be described in greater detail below.

The bicarbonate containing aqueous medium and the bicarbonate rich product may each be a liquid composition that includes a single phase or two or more different phases. In some embodiments, the bicarbonate containing aqueous medium and the bicarbonate rich product may each be an aqueous medium that includes droplets of a liquid condensed phase (LCP) in a bulk fluid, e.g., bulk solution.

While the bulk liquid phase of the bicarbonate containing aqueous medium may vary depending on the particular protocol being performed, aqueous media of interest include pure water as well as water that includes one or more solutes, e.g., monovalent cations, such as Na⁺, K⁺, counterions, e.g., carbonate, hydroxide, etc., where in some instances the aqueous medium may be a bicarbonate buffered aqueous medium. Bicarbonate buffered aqueous media that may make up the bulk liquid phase of the bicarbonate containing aqueous medium include liquid media in which a bicarbonate buffer is present. As such, liquid aqueous media of interest include dissolved CO₂, water, carbonic acid (H₂CO₃), bicarbonate ions (HCO₃⁻), hydronium ions (H₃O⁺), hydroxide ions (OH⁻) and carbonate ions (CO₃²⁻). The constituents of the bicarbonate buffer in the aqueous media are governed by the equation:

CO₂+H₂O [symbol] H₂CO₃ [symbol] H⁺+HCO₃⁻ [symbol] 2H⁺+CO₃²⁻

In aqueous media of interest, the amounts of the different carbonate species components in the media may vary according to the pH. In some instances below around or about pH 4.5, the amount of carbonic acid (and its equivalent form of CO₂(aq)+H₂O) ranges from 50 to 100%, such as 70 to 98%, the amount of bicarbonate ion around or about pH 4-9 ranges from 10 to 98%, such as 20 to 90% and the amount of carbonate ion above around or about pH 9 ranges from 10 to 100%, such as 10 to 70%. The pH of the aqueous media may vary, ranging in some instances from 6 to 11, such as 6 to 10, e.g., 6.5 to 9.5, including 7 to 9.

In some instances, the aqueous medium may contain an amount of monovalent cations. In certain embodiments, the monovalent cation may be a single monovalent cation species (such as Na⁺) or two or more distinct monovalent cation species (e.g., Na⁺, K⁺, etc.). Monovalent cations of interest include, but are not limited to: Na⁺, K⁺, Cs⁺, Rb⁺, NH₄⁺, and Li⁺. Other cations of interest include divalent cations, including, but not limited to: Ca²⁺, Mg²⁺, Be²⁺, Ba²⁺, Sr²⁺, Pb²⁺, Fe²⁺, Hg²⁺, as well as cationic species of Mn, Ni, Zn, Cu, Ce, La, Al, Y, Nd, Zr, Gd, Dy, Ti, Th, U, La, Sm, Pr, Co, Cr, Te, Bi, Ge, Ta, As, Nb, W, Mo, V, etc.

In certain embodiments the bicarbonate containing aqueous medium and the bicarbonate rich product are each an aqueous medium that includes droplets of a liquid condensed phase (LCP). By “liquid condensed phase” or “LCP” is meant a phase of a liquid solution which includes bicarbonate ions wherein the concentration of bicarbonate ions is higher in the LCP phase than in the surrounding, bulk liquid.

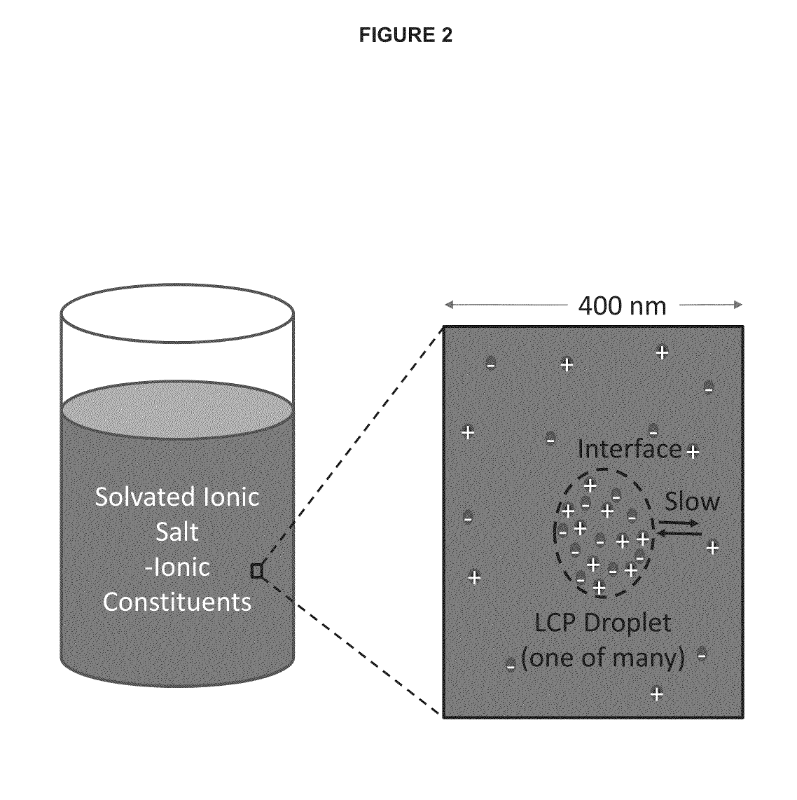

LCP droplets are characterized by the presence of a meta-stable bicarbonate-rich liquid phase in which bicarbonate ions associate into condensed concentrations exceeding that of the bulk solution and are present in a non-crystalline solution state. See e.g., FIG. 2. As can be seen in FIG. 2, the LCP contains many if not all of the components found in the bulk solution that is outside of the interface represented by the dashed line. However, the concentration of the bicarbonate ions is higher than in the bulk solution. In those situations where LCP droplets are present, the LCP and bulk solution may each contain ion-pairs and pre-nucleation clusters (PNCs). When present, the ions remain in their respective phases for long periods of time, as compared to ion-pairs and PNCs in solution. While the number of droplets in a given bicarbonate containing aqueous medium may vary, in some instances there are 1×10⁶ or more droplets/ml of liquid, such as 1×10⁷ or more droplets/ml of liquid, including 1×10⁸ or more droplets/ml of liquid, where in some instances the amount of droplets may be 1×10⁹ or more droplets/ml of liquid, 1×10¹⁰ or more droplets/ml of liquid, 1×10¹¹ or more droplets/ml of liquid, or 1×10¹² or more droplets/ml of liquid, where in some instances the amount of droplets is 1×10¹⁵ or less droplets/ml of liquid, such as 1×10¹³ or less droplets/ml of liquid, including 1×10¹² or less droplets/ml of liquid.

In LCP droplets, the quantity of carbon equivalent molecules, e.g., HCO₃⁻, CO₃²⁻, etc., may vary, and in some instances ranges from 1,000 carbon equivalent molecules to 1,000,000 carbon equivalent molecules per droplet. As such, carbon equivalent concentration of a bicarbonate containing aqueous medium may vary, and may readily be determined using the following formula:

(# carbon equivalent molecules/droplet)×(mol/6.022×10²³ molecules)×(# droplets/mL)×(1000 mL/L)=concentration

In some instances, the carbon equivalent concentration is 10 nM or higher, such as 100 nM or higher, 500 nM or higher, 750 nM or higher, including 1 micromole or higher, 10 micromole or higher, 100 micromole or higher, 500 micromole or higher, 750 micromole or higher, including 1 millimole or higher, such as 10 millimole or higher, wherein in some instances the carbon equivalent concentration is 1 M or less, such as 750 millimole or less, including 500 millimole or less, such as 250 millimole or less, e.g., 100 millimole or less, 50 millimole or less, 10 millimole or less.

In biphasic compositions that include LCP droplets, the pH of the bulk solution may be higher than that of the LCPs, e.g., where the bulk fluid may have a pH in the range of pH 7.0 to pH 10.0, such as pH 7.0 to pH 9.0. Because of the higher concentration of carbon dioxide equivalent molecules in the LCP, the pH of the LCP droplets will be lower when compared to the pH of the bulk solution, e.g., where the pH of the fluid of the LCP droplets may range from 4.9 to pH 6.8, such as between pH 5.2 and pH 6.8. In these embodiments, the pH difference is a result of the carbon equivalent molecules in the LCP pulling in extra protons, or acid, to balance the charge in the LCP. This phenomenon, in turn, allows for more CO₂ to be absorbed in the bulk solution, thus establishing a cycle that enables greater quantities of LCP in the bicarbonate containing aqueous medium.

The bulk phase and LCP are characterized by having different K_{eq}, different viscosities, and different solubilities between phases. Bicarbonate, carbonate, and cationic constituents of the LCP droplets are those that, under appropriate conditions, may aggregate into a post-critical nucleus, leading to nucleation of a solid phase and continued growth. While the association of bicarbonate ions with cations in the LCP droplets may vary, in some instances bidentate bicarbonate ion/cation species may be present. For example, in LCPs of interest, Na⁺/bicarbonate ion bidentate species may be present.

While the diameter of the LCP droplets in the bulk phase of the bicarbonate containing aqueous medium may vary, in some instances the droplets have a diameter ranging from 1 to 500 nm, such as 5 to 250 nm, and including 10 to 100 nm. In some instances, the droplets are charged, and may (in some instances) have a zeta potential ranging from −140 to 120, such as −100 to 40, and including −60 to −5. In some instances, the droplets are charged, where the droplets may be positively or negatively charged, as desired. The higher the magnitude of the charge (whether positive or negative) the more stable the LCP droplets may be. In some instances, the LCP droplets have charge (positive or negative) with a magnitude ranging from 10 to 100, such as 15 to 75, including 20 to 50, e.g., 20 to 40. In the LCP droplets, the bicarbonate to carbonate ion ratio, (i.e., the HCO₃⁻/CO₃²⁻ ratio) may vary, and in some instances is 10 or greater to 1, such as 20 or greater to 1, including 25 or greater to 1, e.g., 50 or greater to 1. Additional aspects of LCPs of interest are found in Bewernitz et al., “A metastable liquid precursor phase of calcium carbonate and its interactions with polyaspartate,” Faraday Discussions. 7 Jun. 2012. DOI: 10.1039/c2fd20080e (2012) 159: 291-312. The presence of LCPs may be determined using any convenient protocol, e.g., the protocols described in Faatz et al., Advanced Materials, 2004, 16, 996-1000; Wolf et al., Nanoscale, 2011, 3, 1158-1165; Rieger et al., Faraday Discussions, 2007, 136, 265-277; and Bewernitz et al., Faraday Discussions, 2012, 159, 291-312.

Where the bicarbonate containing aqueous medium and the bicarbonate rich product each have two phases, e.g., as described above, the first phase may have a higher concentration of bicarbonate ion than a second phase, where the magnitude of the difference in bicarbonate ion concentration may vary, ranging in some instances from 0.1 to 4, such as 1 to 2. For example, in some embodiments, a bicarbonate containing aqueous medium may include a first phase in which the bicarbonate ion concentration ranges from 1000 ppm to 5000 ppm, and a second phase where the bicarbonate ion concentration is higher, e.g., where the concentration ranges from 5000 ppm to 6000 ppm or greater, e.g., 7000 ppm or greater, 8000 ppm or greater, 9000 ppm or greater, 10,000 ppm or greater, 25,000 ppm or greater, 50,000 ppm or greater, 750,000 ppm or greater, 100,000 ppm, 500,000 or greater.

Any suitable method of preparing a bicarbonate containing aqueous medium may be employed for use in the present invention. For example, methods for preparing a bicarbonate containing aqueous medium that includes bicarbonate ions in droplets of an LCP are described in PCT/US2013/058090, the disclosure of which is incorporated herein by reference.

The LCP containing liquid, e.g., as described above, may be produced by any suitable method. In some instances, the LCP containing liquid is produced by contacting a CO₂ containing gas with a bicarbonate buffered aqueous medium under conditions sufficient to produce a bicarbonate containing aqueous medium. The source of CO₂ may be any convenient source, including a pure CO₂ or CO₂ containing multi-component gaseous streams. Examples of sources of CO₂ that may be employed include those specifically listed below. Contact may be done in any manner sufficient to produce the desired LCP containing liquid, including those methods described in international application serial no. PCT/US2013/058090 published as WO2014/039578; the disclosure of which is herein incorporated by reference. In certain instances, a bicarbonate containing aqueous medium that includes bicarbonate ions in droplets of an LCP may be sub saturated with respect to an alkali metal bicarbonate of interest, e.g., sub saturated with respect to sodium bicarbonate. In such instances the pH of the bicarbonate containing aqueous medium may be in the range of 5 to 9, such as 6 to 8, including 6.5 to 7.5. For example, the bicarbonate containing aqueous medium may be at or around pH 7.

The concentration of bicarbonate ions in the bicarbonate containing aqueous medium may vary. In some instances, the concentration of bicarbonate ion in the bicarbonate containing aqueous medium may be, e.g., 5,000 ppm or greater, such as 10,000 ppm or greater, including 15,000 ppm or greater. In certain instances, the concentration of bicarbonate ion in the bicarbonate containing aqueous medium may range from 5,000 to 20,000 ppm, such as 7,500 ppm to 15,000 ppm, including 8,000 to 12,000 ppm. In certain instances, the concentration of bicarbonate ions in the bicarbonate containing aqueous medium may range from 0.1 wt. % to 30 wt. %, such as 3 to 20 wt. %, including from 10 to 15 wt. %. The concentration of bicarbonate ions in the bicarbonate containing aqueous medium may be less than 30 wt. %, such as less than 20 wt. %, less than 10 wt. %, less than 5 wt. %, less than 1 wt. %, including less than 0.1 wt. % or lower.

In some instances, e.g., where the CO₂ source employed to make the LCP includes one or more pollutants, e.g., Pb, Hg, SO₂, NOx, etc., the LCP may be produced in a manner such that the pollutants are preferentially fractionated to one of the two phases related to the other of the two phases of the LCP, i.e., the LCP production protocol may be performed in a manner sufficient to fractionate the pollutants of the CO₂ source between the two phases. Where desired, additives in the solution may be employed that induce pollutants to preferentially reside in one phase or the other. The LCP can then be filtered, e.g., as described below in terms of concentration, from the mother solution to fractionate the pollutant of interest. By engineering the LCP to either sequester or reject the pollutant, the clean bicarbonate rich LCP and precipitate metal bicarbonates may be produced that are relatively non-toxic, pollutant free, e.g., substantially if not completely free of one or more of: Pb, Hg, SO₂, NOx, and other criteria pollutants, etc. As such, food grade alkali metal carbonates may be produced from polluted CO₂ gaseous sources, e.g., flue gas.

As summarized above, aspects of the invention include concentrating a bicarbonate containing aqueous medium to generate a bicarbonate rich product. “Concentrating” as used herein refers to increasing the concentration of one or more components, excluding water, of the aqueous medium. In certain embodiments, concentrating may include increasing the concentration of the droplets of bicarbonate rich liquid condensed phase (BRLCP) in the bicarbonate containing aqueous medium, as described in further detail below. In some embodiments, concentrating may include reducing the amount of water in, i.e. dewatering, the bicarbonate containing aqueous medium. As such, this step may be referred to as a dewatering step.

In some embodiments, concentrating a bicarbonate containing aqueous medium is performed under conditions sufficient to increase the concentration of the droplets of LCP in the bicarbonate containing aqueous medium. In certain embodiments, concentrating a bicarbonate containing aqueous medium generates a bicarbonate rich product that has a higher concentration of droplets of LCP than the bicarbonate containing aqueous medium. For example, the concentration of droplets of LCP in the bicarbonate rich product is higher than the concentration of droplets of LCP in the bicarbonate containing aqueous medium by 1.5 fold or greater, such as 2 fold or greater, 5 fold or greater, 10 fold or greater, 100 fold or greater, 1,000 fold or greater, up to, in some instances 10,000 fold or less, such as 7,500 fold or less, including 5,000 fold or less, e.g., 2,500 fold or less. In some instances, the ratio of the concentration of droplets of LCP in the bicarbonate rich product to the concentration of droplets of LCP in the bicarbonate containing aqueous medium may range from 1.5 to 10,000 fold, such as 2 to 5,000 fold, 5 to 1,000 fold, including 10 to 100 fold.

In certain embodiments, concentrating a bicarbonate containing aqueous medium increases the pH of the bicarbonate containing aqueous medium. In some embodiments, the pH of the bicarbonate rich product may be in the range of 7 to 11, such as 8 to 10, including 8.5 to 9.5. For example, the bicarbonate rich product may be at or around pH 9. Thus, in certain instances, concentrating a bicarbonate containing aqueous medium with a pH at or around 7 generates a bicarbonate rich product with a pH at or around 9. In certain embodiments, the pH of the bicarbonate containing aqueous medium is raised without the use of an external alkalinity source, e.g., NaOH.

In certain embodiments, concentrating a bicarbonate containing aqueous medium increases the concentration of ionic molecules in the bicarbonate containing aqueous medium. For example, concentrating the bicarbonate containing aqueous medium may increase the concentration of ions, including, but not limited to, bicarbonate (HCO₃⁻), carbonate (CO₃²⁻), chloride (Cl⁻), sulfate (SO₄²⁻), sodium (Na⁺), potassium (K⁺), calcium (Ca²⁺), magnesium (Mg²⁺) ions, and the like, in the bicarbonate containing aqueous medium. In certain embodiments, concentrating the bicarbonate containing aqueous medium may increase the concentration of a single ionic species, or may increase the concentration of a plurality of, or substantially all, ionic species in the bicarbonate containing aqueous medium. In certain instances, the concentration of ionic species may increase by the same amount between all ionic species. In other instances, the concentration of ionic species may increase by different amounts between different ionic species. For example, concentrating the bicarbonate containing aqueous medium may increase the concentration of bicarbonate and sodium ions in the bicarbonate containing aqueous medium. In certain instances, concentrating the bicarbonate containing aqueous medium may increase the concentration of carbonate and sodium ions in the bicarbonate containing aqueous medium.

The concentration of carbonate ions in the bicarbonate containing aqueous medium may vary. In some instances, the overall amount of carbonate ion in the bicarbonate containing aqueous medium may range from 10⁻⁴ wt. % or less to 30 wt. %, such as 10⁻³ wt. % to 10 wt. %, 10⁻² wt. % to 1 wt. %, including 10⁻² wt. % to 0.1 wt. %.

In certain embodiments, concentrating the bicarbonate containing aqueous medium generates a bicarbonate rich product that has a higher concentration of ions than the bicarbonate containing aqueous medium. In some instances, the bicarbonate rich product has a higher concentration of one ionic species, several ionic species, or all ionic species relative to the bicarbonate containing aqueous medium. In some embodiments, the bicarbonate rich product has a higher concentration of bicarbonate ions than the bicarbonate containing aqueous medium. In certain embodiment, the bicarbonate rich product has a higher concentration of carbonate ions than the bicarbonate containing aqueous medium.

The concentration of bicarbonate ions in the bicarbonate rich product may, in some instances, be higher by 1.5 fold or greater, such as 2 fold or greater, 5 fold or greater, 10 fold or greater, 100 fold or greater, 1,000 fold or greater, up to, in some instances 10,000 fold or less, such as 7,500 fold or less, including 5,000 fold or less, e.g., 2,500 fold or less, relative to the concentration of bicarbonate ions in the bicarbonate containing aqueous medium. In some instances, the ratio of the concentration of bicarbonate ions in the bicarbonate rich product to the concentration of bicarbonate ions in the bicarbonate containing aqueous medium may range from 1.5 to 10,000, such as 2 to 5,000, 5 to 1,000, including 10 to 100.

The concentration of carbonate ions in the bicarbonate rich product may, in some instances, be higher by 1.5 fold or greater, such as 2 fold or greater, 5 fold or greater, 10 fold or greater, 100 fold or greater, 1,000 fold or greater, up to, in some instances 10,000 fold or less, such as 7,500 fold or less, including 5,000 fold or less, e.g., 2,500 fold or less, relative to the concentration of carbonate ions in the bicarbonate containing aqueous medium. In some instances, the ratio of the concentration of carbonate ions in the bicarbonate rich product to the concentration of carbonate ions in the bicarbonate containing aqueous medium may range from 1.5 to 10,000, such as 2 to 5,000, 5 to 1,000, including 10 to 100.

In certain embodiments, concentrating a bicarbonate containing aqueous medium may increase the dissolved inorganic carbon (DIC) of the bicarbonate containing aqueous medium. The DIC is the sum of the concentrations of inorganic carbon species in a solution, represented by the equation: DIC=[CO₂*]+[HCO₃⁻]+[CO₃²⁻], where [CO₂*] is the sum of carbon dioxide ([CO₂]) and carbonic acid ([H₂CO₃]) concentrations, [HCO₃⁻] is the bicarbonate concentration and [CO₃²⁻] is the carbonate concentration in the solution. The DIC of the bicarbonate containing aqueous media may vary, and in some instances may be 5,000 ppm or greater, such as 10,000 ppm or greater, including 15,000 ppm or greater. In some instances, the DIC may range from 5,000 to 20,000 ppm, such as 7,500 to 15,000 ppm, including 8,000 to 12,000 ppm.

In certain instances, concentrating the bicarbonate containing aqueous medium generates a bicarbonate rich product that has a higher DIC than the bicarbonate containing aqueous medium. The DIC of the bicarbonate rich product may be higher than the DIC of the bicarbonate containing aqueous medium, in some instances by 1.5 fold or greater, such as 2 fold or greater, 5 fold or greater, 10 fold or greater, 100 fold or greater, 1,000 fold or greater, up to, in some instances 10,000 fold or less, such as 7,500 fold or less, including 5,000 fold or less, e.g., 2,500 fold or less. In some instances, the ratio of the DIC of the bicarbonate rich product to the DIC of the bicarbonate containing aqueous medium may range from 1.5 to 10,000, such as 2 to 5,000, 5 to 1,000, including 10 to 100.

Any suitable method of measuring the concentration of ionic species, droplets of LCP or DIC may be employed. For example, the concentration of droplets of LCP may be quantitated using an NS500 nanoparticle tracking analyzer. DIC content may be determined using a UIC CM150 series carbon analyzer. The concentration of ionic species may be measured using any suitable ion selective electrodes. The pH may be measured using any suitable pH-meter.

In some instances the bicarbonate rich product has a concentration of bicarbonate ion that is sufficiently high to produce an alkali metal carbonate upon further processing, e.g., dewatering, contacting with an alkali metal source, or contacting with an alkali metal source and a CO₂ containing gas. In such cases, the bicarbonate rich product may be said to have an equivalent concentration of bicarbonate ion that is sufficiently high to produce an alkali metal carbonate. The “equivalent” concentration of bicarbonate ion, as used herein, refers to the sum of the concentration of bicarbonate ion (HCO₃⁻) and the molar amount of additional bicarbonate ions that would be present if all or at least a fraction of the carbonate ions (CO₃²⁻) present in the bicarbonate rich product were converted to bicarbonate ions. For example, if the bicarbonate rich product contained 100 mM bicarbonate and 100 mM carbonate ions, the “equivalent” concentration of bicarbonate ion as defined herein is greater than 100 mM, up to 200 mM.

Thus in certain embodiments, a bicarbonate rich product that has a sufficiently high equivalent concentration of bicarbonate ion has an equivalent concentration of bicarbonate ion that is supersaturated with respect to a bicarbonate salt of a specific alkali metal (i.e., the bicarbonate rich product is a supersaturated aqueous medium of an alkali metal bicarbonate, e.g. sodium bicarbonate), at the temperature, pressure and pH of the bicarbonate rich product. In such instances, the bicarbonate rich product may contain carbonate ions at sub saturating concentrations with respect to the carbonate salt of the same alkali metal (i.e., the bicarbonate rich product is a sub saturated solution of an alkali metal carbonate, e.g., sodium carbonate) at the temperature and pressure of the bicarbonate rich product. In other words, the bicarbonate rich product may include a mixture of bicarbonate and carbonate ions such that if all or at least a fraction of the carbonate ions were converted to bicarbonate ions, the total concentration of bicarbonate ions will be higher than the saturation concentration of a bicarbonate salt of an alkali metal of interest, e.g., higher than the saturation concentration of sodium bicarbonate, at the temperature, pressure and pH of the aqueous medium.

In certain embodiments, a bicarbonate containing aqueous medium that includes bicarbonate ions in droplets of an LCP is concentrated to generate a bicarbonate rich product such that the concentration of sodium bicarbonate in the bicarbonate rich product is sufficiently high to produce an alkali metal carbonate. For example, concentrating the bicarbonate containing aqueous medium may generate a supersaturated bicarbonate solution with respect to an alkali metal bicarbonate salt of interest, e.g., a supersaturated sodium bicarbonate solution. In such instances, concentrating the sub saturated bicarbonate solution may generate a sub saturated carbonate solution, e.g., a sub saturated sodium carbonate solution. In other words, increasing the concentration of bicarbonate ion in the sub saturated bicarbonate solution may generate a bicarbonate rich product that contains an equivalent concentration of carbonate ions that is above the saturation concentration of bicarbonate with respect to an alkali metal of interest, e.g. the saturation concentration of sodium bicarbonate.

In some embodiments, concentrating the bicarbonate containing aqueous medium does not cause precipitation of substantial amounts of sodium bicarbonate in the bicarbonate rich product. In some instances, concentrating the bicarbonate containing aqueous medium causes precipitation of less than 5%, such as less than 1%, less than 0.5%, less than 0.1%, including less than 0.01% or less, down to, in some instances, 0.001% or more, e.g., 0.01% or more, 0.05% or more, 0.1% or more, including, e.g., 1% or more of the total amount of precipitatable sodium bicarbonate in the bicarbonate rich product. In certain instances, concentrating the bicarbonate containing aqueous medium causes precipitation in the range of 0.001 to 5%, such as 0.005 to 1%, including 0.01 to 0.1%, of the total amount of precipitatable sodium bicarbonate in the bicarbonate rich product. In some instances, concentrating the bicarbonate containing aqueous medium causes essentially no precipitation of sodium bicarbonate in the bicarbonate rich product.

### Concentrating a Bicarbonate Containing Aqueous Medium

Any suitable method of concentrating a bicarbonate containing aqueous medium may be employed to generate a bicarbonate rich product from a bicarbonate containing aqueous medium. In performing the methods of the present invention, the concentrating step may be repeated one or more times, as desired. In certain embodiments, concentrating a bicarbonate containing aqueous medium to generate a bicarbonate rich product is effected without the use of an additional source of carbon, such as, but not limited to, CO₂ containing gas and trona ore.

In certain embodiments, concentrating a bicarbonate containing aqueous medium includes dewatering a bicarbonate containing aqueous medium to generate a bicarbonate rich product. In such instances, dewatering may involve preferentially separating water molecules from the droplets of a bicarbonate rich liquid condensed phase (BRLCP) in the bulk liquid of the bicarbonate containing aqueous medium. In other words, dewatering may separate at least a portion of the water component of the bicarbonate containing aqueous medium from the BRLCP components. In some instances, dewatering the bicarbonate containing aqueous medium by separation of water molecules from the BRLCP may be based on one or more characteristics, where such characteristics include, but are not limited to, one or more of: size, charge, viscosity, density, pH, solute composition and the like. Any suitable method of dewatering the bicarbonate containing aqueous medium may be used, including, but not limited to, membrane separation techniques, as described in further detail below.

In some instances, separation of water molecules from the BRLCP in a bicarbonate containing aqueous medium (i.e., dewatering) is accomplished using selective ion separation. In certain embodiments, a selective ion separator may be a size-based ion separator that includes a selective membrane, such as a semi-permeable membrane, which allows molecules and ions under a certain size to pass through, while preventing larger molecules and ions from passing through. In certain embodiments, dewatering a bicarbonate containing aqueous medium is accomplished using membrane separation techniques, such as, but not limited to, reverse osmosis, ultrafiltration, and nanofiltration. In other words, in certain embodiments, a bicarbonate containing aqueous medium may be concentrated to generate a bicarbonate rich product by a membrane separation technique, such as, but not limited to, reverse osmosis, ultrafiltration, and nanofiltration.

A suitable selective membrane employed in the methods of the invention may exhibit a rejection rate with respect to BRLCP compositions of 30% or greater, such as 40% or greater, 50% or greater, 60% or greater, 70% or greater, 80% or greater, 90% or greater, 95% or greater, 98% or greater, up to, in some instances, about 100% or less, such as 95% or less, 85% or less, 75% or less, 65% or less, including 55% or less. In certain embodiments, the selective membrane may reject BRLCP compositions at a rate ranging from 30-100%, such as 40-99%, 50-98%, 70-95%, including 80-90%.

In some embodiments, the selective membrane may comprise pores ranging in size from about 1 Angstrom, up to about 10 Angstroms, up to about 20 Angstroms, up to about 30 Angstroms, up to about 40 Angstroms, up to about 50 Angstroms, up to about 60 Angstroms, up to about 70 Angstroms, up to about 80 Angstroms, up to about 90 Angstroms, up to about 100 Angstroms, up to about 200 Angstroms, up to about 300 Angstroms, up to about 400 Angstroms, up to about 500 Angstroms, up to about 600 Angstroms, up to about 700 Angstroms, up to about 800 Angstroms, up to about 900 Angstroms or more. In some embodiments, the selective membrane may include pores ranging in size from about 1 to 900 Angstroms or more, such as from about 10 to 800 Angstroms, about 20 to 700 Angstroms, about 30 to 600 Angstroms, about 40 to 500 Angstroms, about 50 to 400 Angstroms, about 60 to 300 Angstroms, about 70 to 200 Angstroms, including about 80 to 100 Angstroms. In some embodiments, the selective membrane includes a reverse osmosis (RO) membrane that has pores ranging in size from about 5 Angstroms, up to about 6 Angstroms, up to about 7 Angstroms, up to about 8 Angstroms. Such membranes are generally impermeable to ions, but allow water molecules to pass through the membrane.

In some embodiments, the selective membrane may include a nano-filtration (NF) membrane having pores ranging in size from about 1 nanometer up to about 2 nanometers, up to about 5 nanometers, up to about 8 nanometers, up to about 10 nanometers. The pore size of the NF membrane may range between 1-10 nanometer, such as 2-8 nanometers, including 3-5 nanometers. In addition to selection by size, NF membranes may reject divalent ions but allow monovalent ions to pass through.

In some embodiments, the selective membrane may include an ultra-filtration (UF) membrane having pores ranging in size from about 10 nanometers, up to about 20 nanometers, up to about 30 nanometers. The pore size of the UF membrane may range between 10-30 nanometers, such as 10-20 nanometers, including 10-15 nanometers. Such membranes may be used to separate larger molecules from solutions by retaining the larger molecules on a first side of the membrane while allowing the solution to pass through the membrane.

Thus, in some embodiments, a bicarbonate containing aqueous medium may be introduced to a first side of a size-based ion separator and as water molecules are transported through, or across, the size-based ion separator, the BRLCP components of the bicarbonate containing aqueous medium may be retained on the first side of the size-based ion separator. Net movement of water out of the bicarbonate containing aqueous medium through, or across, the size-based ion separator into the permeate may concentrate the bicarbonate containing aqueous medium in the retentate, as described above.

In certain embodiments, a bicarbonate containing aqueous medium may be introduced to a first side of a size-based ion separator under conditions sufficient to separate water from the BRLCP compositions, as described above. In such instances, net movement of water from the bicarbonate containing aqueous medium through, or across, the size-based separator into a second side of the size-based ion separator may be accomplished by the presence of a driving force applied to the water molecules in the bicarbonate containing aqueous medium. In certain instances, the driving force is a pressure applied to the bicarbonate containing aqueous medium. In some instances, the driving force is an osmotic pressure.

In certain embodiments a bicarbonate containing aqueous medium may be introduced to a first side of a size-based ion separator under sufficient pressure such that water molecules are forced through, or across, the size-based ion separator. In other words, sufficient pressure may be applied to the bicarbonate containing aqueous medium introduced to a first side of a size-based ion separator such that water is forced through, or across, the size-based ion separator. In such instances, the bicarbonate containing aqueous medium may be introduced to a first side of a size-based ion separator under pressure in the range from about 50 psi, up to about 75 psi, up to about 100 psi, up to about 125 psi, up to about 150 psi, up to about 175 psi, up to about 200 psi, up to about 225 psi, up to about 250 psi, including up to about 500 psi, or more, to force water molecules through, or across the size-based ion separator. In such instances, the size-based ion separator may be a RO membrane, a NF membrane, or an UF membrane with sufficiently small pore sizes to separate water from the BRLCP compositions in the bicarbonate containing aqueous medium, as described above.

In some embodiments, dewatering a bicarbonate containing aqueous medium includes a forward osmosis mediated process. In other words, in certain embodiments, a bicarbonate containing aqueous medium may be concentrated by forward osmosis to generate a bicarbonate rich product. In such instances, a bicarbonate containing aqueous medium is introduced into a first side of a size-based ion separator, such as a semi-permeable membrane, as described above, and water in the bicarbonate containing aqueous medium is transported through, or across, the size-based ion separator into a “draw” liquid present at a second side of the size-based ion separator. The draw liquid may be any suitable liquid that has a high concentration of solutes relative to the concentration of solutes of the bicarbonate containing aqueous medium. In other words, the osmotic potential of the draw liquid may be lower than the osmotic potential of the bicarbonate containing aqueous medium. In such cases, the difference in osmotic potential between the two sides of the semi-permeable membrane creates a driving force for water molecules to migrate from an area of high osmotic potential (i.e., the bicarbonate containing aqueous medium) to an area of low osmotic potential (i.e., the draw liquid). The magnitude of the difference in osmotic potential between a given draw liquid and the bicarbonate containing aqueous medium (i.e., the magnitude of the osmotic pressure between the draw liquid and the bicarbonate containing aqueous medium separated by a semi-permeable membrane) may vary, and in some instances ranges from 0.1 bar to 150 bar, such as 20 bar to 60 bar, including 25 bar to 35 bar.

Any suitable liquid may be employed as the draw liquid. Draw liquids of interest include aqueous media having a salinity of 2 parts per thousand (ppt) or more, such as 5 ppt or more, including 10 ppt or more. In some instances the draw liquid is an aqueous medium having a salinity that ranges from 3 to 50 ppt, such as 5 to 35 ppt. The pH of the brine draw liquid may vary, and in some instances ranges from 4 to 12, such as 5 to 10 and including 6 to 9. In some instances, the draw liquid may be referred to as a brine draw liquid. The brine draw liquid may include water saturated or nearly saturated with salt and has a salinity that is 50 ppt or greater, such as 60 ppt or greater, and including 95 ppt or greater. Brine draw liquids of interest include, but are not limited to: man-made brines, such as geothermal plant wastewaters, oil field produced brines, fracking operation produced waters, desalination waste waters, etc., as well as natural brines, such as surface brines found in bodies of water on the surface of the earth and deep brines, found underneath the earth), as well as other salines having a salinity as described above.

In some instances, the draw liquid has an alkalinity that is much greater than that of the bicarbonate containing aqueous medium, so that hydrogen and hydronium ions from the bicarbonate containing aqueous medium may be drawn to the draw liquid side through the membrane, along with water, causing a pH gradient and making the bicarbonate containing aqueous medium more alkaline, i.e. increasing the pH of the bicarbonate containing aqueous medium. In some instances, the draw liquid has an alkalinity ranging from 1 to 1000 mM concentration, such as from 10-100 mM concentration, and including over 1000 mM alkalinity concentration or more.

The temperature under which the bicarbonate containing aqueous medium is concentrated may vary. In some instances, the temperature ranges from −1.4 to 100° C., such as 20 to 80° C. and including 40 to 70° C. In some instances, the temperature may range from −1.4 to 50° C. or higher, such as from −1.1 to 45° C. or higher. In some instances, the temperature of the bicarbonate containing aqueous medium may be 25° C. or higher, such as 30° C. or higher, and may in some embodiments range from 25 to 50° C., such as 30 to 40° C. While a given aqueous medium may be warmed in such instances to arrive at these temperatures, in some instances the aqueous medium may be obtained from a source that provides the desired temperature, e.g., from the output of a carbon capture process at an industrial plant, for example.

### Alkali Metal Ion Source

Any convenient source of alkali metal ion may be employed in the methods of the invention. In certain instances, the alkali metal ion source may be in the form of a liquid, such as a brine, or in the form of a salt or mineral. Liquid forms of the alkali metal source that is contacted with the bicarbonate containing aqueous medium may include waters obtained from seas, oceans, estuaries, lagoons, brines, alkaline lakes, inland seas, etc. Man-made sources of brine from water processing facilities such as sea water desalination plants, brackish water desalination plants, groundwater recovery facilities, wastewater facilities, and the like, which produce a concentrated stream of solution high in cation contents, may also be employed. Mineral forms of the alkali metal source may be derived from the liquid sources of alkali metal ions by any suitable method, such as through evaporation.

The alkali metal source may contain an amount of monovalent cations. In certain embodiments, the alkali metal source may include alkali metal cations, including a single monovalent cation species (such as Na⁺) or two or more distinct monovalent cation species (e.g., Na⁺, K⁺, etc.). Monovalent cations of interest include, but are not limited to: Na⁺, K⁺, Cs⁺, Rb⁺, and Li⁺. In certain embodiments, the alkali metal ion source may include a counter ion, e.g., an anion. Anions of interest include, but are not limited to, Cl⁻, Br⁻, NO₃⁻, SO₄⁻, ClO₄⁻, ClO₃⁻, I⁻ and the like.

In certain embodiments the alkali metal ion source may include, e.g., a chloride salt of an alkali metal ion. Alkali metal ions of interest include, but are not limited to, Na⁺, K⁺, Cs⁺, Rb⁺, as described above. In certain embodiments, the alkali metal ion source includes sodium chloride. In yet other embodiments, the alkali metal ion source includes potassium chloride.

In some embodiments, the source of alkali metal ion may include a pure source of an alkali metal ion. A pure source of an alkali metal ion may include substantially a single species of an alkali metal ion (e.g., Na⁺). In yet other embodiments, the source of alkali metal ion may include a mixture of several distinct monovalent cationic species (e.g., Na⁺, K⁺, etc.). In yet other embodiments, the source of alkali metal ion may include a mixture of several distinct cationic species (e.g., Na⁺, K⁺, Ca²⁺, etc.). In some embodiments, the alkali metal ion source that is present a mixture of several distinct cation species may be processed by, e.g., filtration, ion exchange, etc., to remove certain cationic species. For example, an ion exchange membrane or column may be employed to remove a substantial portion of divalent cations (e.g., Mg²⁺, Ca²⁺) from the alkali metal ion source.

In some embodiments, the concentration of alkali metal ions in a liquid form of the alkali metal ion source may range from 0.05 wt. % to 30 wt. %, such as 0.1 wt. % to 20 wt. %, 0.5 wt. % to 10 wt. %, including to 1.0 wt. % to 8 wt. %, etc. In certain embodiments, the concentration of sodium ions my range from 0.05 wt. % to 30 wt. %, such as 0.1 wt. % to 20 wt. %, 0.5 wt. % to 10 wt. %, including to 1.0 wt. % to 8 wt. %, etc.

In certain embodiments, the alkali metal ion source may include an alkali metal salt or mineral. A mineral alkali metal ion source may be a crystalline solid or an amorphous solid, or a mixture of each. For example, an alkali metal mineral may be a crystalline alkali metal salt. Any suitable salt of an alkali metal may be used, e.g., chloride, sulfate, nitrate, bromate, perchlorate, chlorate, iodide salts, and the like.

Depending on the particle size of the mineral alkali metal ion source, the alkali metal mineral may be crushed, pulverized, ground, comminuted, or the like in a size reducer. In certain embodiments, the particle size of the alkali metal mineral may be 1000 μm or less, such as 900 μm or less, 800 μm or less, 700 μm or less, 600 μm or less, 500 μm or less, 400 μm or less, 300 μm or less, 200 μm or less, 150 μm or less, 100 μm or less, 75 μm or less, including 50 μm or less in the longest dimension. In some embodiments, the particle size of the solid alkali metal mineral may be 50 μm or greater, such as 75 μm or greater, 100 μm or greater, 150 μm or greater, 200 μm or greater, 300 μm or greater, 400 μm or greater, 500 μm or greater, 600 μm or greater, 700 μm or greater, 800 μm or greater, 900 μm or greater, including 1000 μm or greater in the longest dimension. In some embodiments, the particle size of the alkali metal mineral may be between 50-500 μm, or between 50-200 μm, or between 50-100 μm.

### Carbon Dioxide Containing Gas

In certain embodiments, methods of the invention include contacting a bicarbonate rich product with an alkali metal ion source and a carbon dioxide (CO₂) containing gas. The CO₂ containing gas that is processed in methods of the invention is one that includes CO₂. The CO₂ containing gas may be pure CO₂ or be combined with one or more other gasses and/or particulate components, depending upon the source, e.g., it may be a multi-component gas (i.e., a multi-component gaseous stream). While the amount of CO₂ in such gasses may vary, in some instances the CO₂ containing gasses have a pCO₂ of 10³ Pa or higher, such as 10⁴ Pa or higher, such as 10⁵ Pa or higher, including 10⁶ Pa or higher. The amount of CO₂ in the CO₂ containing gas, in some instances, may be 20,000 or greater, e.g., 50,000 ppm or greater, such as 100,000 ppm or greater, including 150,000 ppm or greater, e.g., 500,000 ppm or greater, 750,000 ppm or greater, 900,000 ppm or greater, up to including 1,000,000 ppm or greater (In pure CO₂ exhaust the concentration is 1,000,000 ppm). In some instances the mount of CO₂ in the CO₂ containing gas may range from 10,000 to 500,000 ppm, such as 50,000 to 250,000 ppm, including 100,000 to 150,000 ppm. The temperature of the CO₂ containing gas may also vary, ranging in some instances from 0 to 1800° C., such as 10 to 100° C. and including 30 to 70° C.

As indicated above, in some instances the CO₂ containing gasses are not pure CO₂, in that they contain one or more additional gasses and/or trace elements. Additional gasses that may be present in the CO₂ containing gas include, but are not limited to water, nitrogen, mononitrogen oxides, e.g., NO, NO₂, and NO₃, oxygen, sulfur, monosulfur oxides, e.g., SO, SO₂ and SO₃), volatile organic compounds, e.g., benzo(a)pyrene C₂OH₁₂, benzo(g,h,l)perylene C₂₂H₁₂, dibenzo(a,h)anthracene C₂₂H₁₄, etc. Particulate components that may be present in the CO₂ containing gas include, but are not limited to particles of solids or liquids suspended in the gas, e.g., heavy metals such as strontium, barium, mercury, thallium, etc.

In certain embodiments, CO₂ containing gasses are obtained from an industrial plant, e.g., where the CO₂ containing gas is a waste feed from an industrial plant. Industrial plants from which the CO₂ containing gas may be obtained, e.g., as a waste feed from the industrial plant, may vary. Industrial plants of interest include, but are not limited to, power plants and industrial product manufacturing plants, such as but not limited to chemical and mechanical processing plants, refineries, cement plants, steel plants, etc., as well as other industrial plants that produce CO₂ as a byproduct of fuel combustion or other processing step (such as calcination by a cement plant). Waste feeds of interest include gaseous streams that are produced by an industrial plant, for example as a secondary or incidental product, of a process carried out by the industrial plant.

Of interest in certain embodiments are waste streams produced by industrial plants that combust fossil fuels, e.g., coal, oil, natural gas, as well as man-made fuel products of naturally occurring organic fuel deposits, such as but not limited to tar sands, heavy oil, oil shale, etc. In certain embodiments, power plants are pulverized coal power plants, supercritical coal power plants, mass burn coal power plants, fluidized bed coal power plants, gas or oil-fired boiler and steam turbine power plants, gas or oil-fired boiler simple cycle gas turbine power plants, and gas or oil-fired boiler combined cycle gas turbine power plants. Of interest in certain embodiments are waste streams produced by power plants that combust syngas, i.e., gas that is produced by the gasification of organic matter, e.g., coal, biomass, etc., where in certain embodiments such plants are integrated gasification combined cycle (IGCC) plants. Of interest in certain embodiments are waste streams produced by Heat Recovery Steam Generator (HRSG) plants. Waste streams of interest also include waste streams produced by cement plants. Cement plants whose waste streams may be employed in methods of the invention include both wet process and dry process plants, which plants may employ shaft kilns or rotary kilns, and may include pre-calciners. Each of these types of industrial plants may burn a single fuel, or may burn two or more fuels sequentially or simultaneously. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant.

Another source of carbon dioxide containing gas of interest includes substantially pure CO₂ gas generated during production of carbonate compositions in a CO₂ gas sequestration process, as described in PCT/US2013/058090 published as WO2014/039578, the disclosure of which is herein incorporated by reference.

### Precipitation Conditions

As summarized above, aspects of the present invention include concentrating a bicarbonate containing aqueous medium to generate a bicarbonate rich product and contacting the bicarbonate rich product with an alkali metal ion source under conditions sufficient to produce an alkali metal carbonate. In some embodiments, a bicarbonate rich product is contacted with a CO₂ containing gas and an alkali metal ion source under conditions sufficient to produce an alkali metal carbonate.

The bicarbonate rich product may be contacted with an alkali metal ion source using any convenient method. For example, contact protocols of interest include, but are not limited to: direct contacting protocols, e.g., mixing the bicarbonate rich product with bulk liquid of an alkali metal ion source through turbulent flow or with fine droplets of a liquid alkali metal ion source; concurrent contacting protocols, i.e., contact between unidirectionally flowing liquid phase streams, or contact between a flowing liquid phase and a fluidized bed of a solid alkali metal ion source; countercurrent protocols, i.e., contact between oppositely flowing liquid phase streams, and the like.

Conditions sufficient to produce an alkali metal carbonate from a bicarbonate rich product that is contacted with an alkali metal ion source may include conditions that favor precipitation of the alkali metal carbonate. Thus, certain aspects of the invention include precipitating an alkali metal carbonate from a bicarbonate rich product that is contacted with an alkali metal ion source under conditions that are sufficient to precipitate and/or that favor precipitation of the alkali metal carbonate. In these instances, conditions that favor precipitation of an alkali metal carbonate may include, but are not limited to, dewatering, CO₂ exposure, pH, pressure, temperature, ionic composition and concentration, or a combination thereof.

Any suitable method for dewatering may be employed to precipitate an alkali metal carbonate from a bicarbonate rich product, including, but not limited to, membrane separation, such as described above, evaporation, including vapor-compression evaporation, or distillation. In certain embodiments, the bicarbonate rich product is sub saturated with respect to a carbonate salt of an alkali metal, e.g. sodium carbonate, at the pressure and temperature of the bicarbonate rich product, as described above. Dewatering the bicarbonate rich product by, for example, membrane separation, evaporation or distillation, may cause precipitation of an alkali metal carbonate, e.g., sodium carbonate salt, as the concentration of carbonate ion is raised above the saturation concentration of the alkali metal carbonate, e.g., sodium carbonate. Thus, in certain embodiments, dewatering a bicarbonate rich product promotes the precipitation of sodium carbonate from the bicarbonate rich product. Methods of precipitating alkali metal carbonates in solution by dewatering are disclosed in, for example, U.S. Pat. Nos. 5,283,054, 5,618,504, and 7,410,627, the disclosures of which are incorporated herein by reference.

In yet another embodiment, the bicarbonate rich product is contacted with a CO₂ containing gas and an alkali metal ion source under conditions sufficient to produce an alkali metal carbonate, as described above. For example, contacting the bicarbonate rich product with the alkali metal ion source and a CO₂ containing gas may promote precipitation of an alkali metal salt from the bicarbonate rich product. In some instances, contacting the bicarbonate rich product with the alkali metal ion source and a CO₂ containing gas under conditions sufficient to produce an alkali metal carbonate produces an alkali metal bicarbonate salt, e.g., a sodium bicarbonate salt. In some instances, a CO₂ containing gas is added to a concentrated carbonate solution (pH 8.5 or greater, such as 9 or greater, 10 or greater, 11 or greater) which makes the solution become concentrated in bicarbonate (<pH 8.5) which is supersaturated with respect to bicarbonate salts, which in turn leads to precipitation of the desired alkali metal carbonate.

In certain embodiments, the bicarbonate rich product may be sub saturated with respect to an alkali metal carbonate, e.g., sodium carbonate, and have an equivalent concentration that is supersaturated with respect to the bicarbonate salt of the same alkali metal, e.g., sodium bicarbonate, as described above. In such cases, contacting the bicarbonate rich product with a CO₂ containing gas and an alkali metal ion, e.g., Na⁺, source may promote precipitation of an alkali metal bicarbonate salt, e.g., sodium bicarbonate. The CO₂ from the CO₂ containing gas dissolves into the bicarbonate rich product, lowers the pH of the medium and reacts with the carbonate ions to produce additional bicarbonate ions. The burst of extra bicarbonate ions combined with the added alkali metal ion causes precipitation of the alkali metal bicarbonate salt from the supersaturated bicarbonate rich product.

The CO₂ containing gas may be contacted with the bicarbonate rich product using any convenient protocol. For example, contact protocols of interest include, but are not limited to: direct contacting protocols, e.g., bubbling the gas through a volume of the aqueous medium, concurrent contacting protocols, i.e., contact between unidirectionally flowing gaseous and liquid phase streams, countercurrent protocols, i.e., contact between oppositely flowing gaseous and liquid phase streams, and the like.

The pH under which alkali metal carbonate precipitation is performed may vary. In certain instances, higher pH may favor precipitation of a carbonate salt of an alkali metal, whereas a lower pH may favor precipitation of a bicarbonate salt of an alkali metal. For example, a carbonate salt of an alkali metal may preferentially precipitate when the pH of the bicarbonate rich product is in the range of 8.5 to 12.5, such as 10 to 12, including 10.5 to 11.5. A carbonate salt of an alkali metal may preferentially precipitate when the pH of the bicarbonate rich product is around 9. In certain embodiments, lowering the pH of the bicarbonate rich product, for example, by contacting the bicarbonate rich product with a CO₂ containing gas as described above, may promote precipitation of an alkali metal bicarbonate. The pH may be lowered, in some instances, by 0.5 or more, such as 0.6 or more, 0.7 or more, 0.8 or more, 0.9 or more, 1.0 or more, 1.2 or more, 1.5 or more, 1.8 or more, 2 of more, 2.5 or more, 3 or more, up to, in some instances 4 or less, such as 3.5 or less, 3 or less, including 2 or less, e.g., 1 or less to promote precipitation of an alkali metal bicarbonate. In some instances, the pH of the bicarbonate rich product may be lowered by a value in the range of 0.5 to 4, such as 0.8 to 3, including 1.0 to 2.

In some embodiments, where the bicarbonate rich product is a pressurized composition, as described above, the pressure applied to a bicarbonate rich product that is contacted with an alkali metal ion source and/or a CO₂ containing gas may be reduced to a level which promotes precipitation of alkali metal salts from the bicarbonate rich product. In some instances, the pressure is reduced by 15 psi or more, such as 150 psi or more, and in some instances by a value ranging from 2000 to 15 psi, such as 200 to 15 psi.

The temperature under which a bicarbonate rich product is contacted with an alkali metal ion source and/or a CO₂ containing gas may vary. In some instances, the temperature ranges from −1.4 to 100° C. or more, such as 20 to 80° C. and including 40 to 70° C. In some instances, the temperature may range from −1.4 to 50° C. or higher, such as from −1.1 to 45° C. or higher. In some instances, the temperature of the bicarbonate rich product may be 25° C. or higher, such as 30° C. or higher, and may in some embodiments range from 25 to 50° C., such as 30 to 40° C. The bicarbonate rich product and the alkali metal ion source may be at the same temperature, or they may be at different temperatures. In some instances, the temperature of the alkali metal ion source ranges from −1.4 to 100° C. or more, such as 20 to 80° C. and including 40 to 70° C. In some instances, the temperature may range from −1.4 to 50° C. or higher, such as from −1.1 to 45° C. or higher. In some instances, the temperature of the alkali metal ion source may be 25° C. or higher, such as 30° C. or higher, and may in some embodiments range from 25 to 50° C., such as 30 to 40° C. While the bicarbonate rich product or the alkali metal ion source may be warmed in such instances to arrive at these temperatures, in some instances each may be obtained from a source that provides the desired temperature, e.g., from the output of a reactor for producing a bicarbonate containing aqueous medium and a desalination plant, for example.

In other words, in certain embodiments, a bicarbonate containing aqueous medium when concentrated without the use of substantial heat, may be at a sufficient temperature to produce an alkali metal carbonate when contacted with an alkali metal ion source and/or a CO₂ containing gas.

In certain embodiments, precipitation of the alkali metal carbonate from a bicarbonate rich product that is contacted with an alkali metal ion source and/or a CO₂ containing gas is promoted by reducing the temperature of the bicarbonate rich product. In certain instances, the temperature of the bicarbonate rich product may be reduced by 10° C. or more, such as 20° C. or more, 30° C. or more, 50° C. or more, 80° C. or more, 100° C. or more, up to, in some instances, 120° C. or less, such as 110° C. or less, 90° C. or less, 70° C. or less, 50° C. or less, including, e.g., 30° C. or less to promote precipitation of the alkali metal carbonate. In certain instances, the temperature of the bicarbonate rich product may be reduced by a value ranging from 10-120° C., such as 30-100° C., 50-80° C., including 60-70° C. Methods of promoting alkali metal carbonate precipitation by cooling are described in, for example, U.S. Pat. Nos. 5,989,505 and 5,618,504, and PCT/NL2011/050678, the disclosures of which are incorporated herein by reference.

In certain embodiments, precipitation of the alkali metal carbonate from a bicarbonate rich product does not require substantially reducing the temperature of the aqueous medium. In certain embodiments, precipitation of the alkali metal carbonate from the combined composition of a bicarbonate rich product and an alkali metal ion source does not require substantially reducing the temperature of the combined composition. In certain embodiments, precipitation of the alkali metal salt product from the combined composition of a bicarbonate rich product, an alkali metal ion source and a CO₂ containing gas does not require substantially reducing the temperature of the combined composition.

Where desired, modifying components may be provided in the bicarbonate rich product being subjected to alkali metal carbonate precipitation conditions in order to influence the alkali metal carbonate precipitation process in some desirable manner, e.g., in terms of rate, identity of product alkali metal salts, etc. For example, ions in the bulk phase that partition between the LCP and the bulk solution phase in the bicarbonate rich product, may be employed as catalysts to the phase separation into two liquids. Manipulation of these partitioned companion ions may be optimized to guide the growth of the precipitated solid phase. The ultimate alkali metal salt product may impact the decision of which influencing ion to employ in such embodiments.

In certain embodiments, removal of ionic species may prevent precipitation of salts of carbonic acid that are not desired, e.g., carbonate salts of divalent cations, including, but not limited to calcium carbonate, magnesium carbonate, and the like. In such instances, separation of unwanted ionic species may be achieved by any suitable separation method, including charge-based separation methods. For example, the bicarbonate rich product, before or after concentrating, may be contacted with ion-exchange materials, such as ion exchange resins, zeolites, and the like, to remove unwanted ionic species, such as Ca²⁺ and Mg²⁺. Examples of ion exchange resins include: strongly acidic resins that include, e.g., sulfonic acid groups, such as sodium polystyrene sulfonate or poly(2-acrylamido-2-methyl-1-propanesulfonic acid); weakly acidic resins that include, e.g., carboxylic acid groups; strongly basic resins that include, e.g., quarternary amino groups, such as trimethly ammonium groups; and weakly basic resins that include, e.g., primary, secondary, and/or tertiary amino groups, such as polyethyleneimine. In certain instances, nanofiltration membranes may be used as a charge-based separation method to remove, for example, divalent ions such as Ca²⁺ and Mg²⁺, from the bicarbonate rich product.

### Alkali Metal Carbonates

The alkali metal carbonates of interest may be an amorphous or crystalline salt, or mineral, of carbonic acid. The particular mineral profile, i.e., the identity of the different types of different alkali metal salts and the amounts of each, in the alkali metal salt composition may vary and will be dependent on the particular nature of the bicarbonate containing aqueous media and alkali metal source from which it is derived, as well as the particular conditions employed to derive it. In certain embodiments, the alkali metal salt compounds are present as small particles, e.g., with particle sizes ranging from 0.1 microns to 500 microns or more, e.g., 1 to 500 microns, or 10 to 400 microns, or 50 to 300 microns, as determined by Scanning electron microscopy. In some embodiments, the particle sizes exhibit a bimodal or multi-modal distribution. In certain embodiments, the particles have a high surface are, e.g., ranging from 0.5 to 100 m²/gm, 0.5 to 50 m²/gm, such as from 0.5 to 2.0 m²/gm, as determined by Brauner, Emmit, & Teller (BET) Surface Area Analysis. In some embodiments, alkali metal salt minerals produced by methods of the invention may include rod-shaped crystals and amorphous solids. The rod-shaped crystals may vary in structure, and in certain embodiments have length to diameter ratio ranging from 500 to 1, such as 10 to 1. In certain embodiments, the length of the crystals ranges from 0.5 μm to 500 μm, such as from 5 μm to 100 μm. In yet other embodiments, substantially completely amorphous solids are produced.

The precipitated product may include one or more different alkali metal salts, such as two or more different alkali metal salts, e.g., three or more different alkali metal salts, five or more different alkali metal salts, etc., including non-distinct, amorphous alkali metal salts. Carbonate compounds of precipitated products of the invention may be compounds having a molecular formulation Xₘ(CO₃)ₙ where X is any element or combination of elements that can chemically bond with a carbonate group or its multiple, wherein X is in certain embodiments an alkali metal; wherein m and n are stoichiometric positive integers. These carbonate compounds may have a molecular formula of Xₘ(CO₃)ₙ.H₂O, where there are one or more structural waters in the molecular formula. The amount of carbonate in the product, as determined by coulometry using the protocol described as coulometric titration, may be 40% or higher, such as 70% or higher, including 80% or higher.

Bicarbonate compounds of precipitated products of the invention may be compounds having a molecular formulation Xₘ(HCO₃)ₙ where X is any element or combination of elements that can chemically bond with a bicarbonate group or its multiple, wherein X is in certain embodiments an alkali metal; wherein m and n are stoichiometric positive integers. The amount of bicarbonate in the product, as determined by acid titration, may be 40% or higher, such as 70% or higher, including 80% or higher.

The alkali metal salts of the precipitated products may include a number of different cations, such as, but not limited to, ionic species of: sodium, potassium, lithium, cesium, rubidium, and combinations thereof. Of interest are carbonate salts of monovalent metal cations, such as sodium and potassium salts. Specific alkali metal carbonates of interest include, but are not limited to: sodium bicarbonate, sodium carbonate, potassium bicarbonate and potassium carbonate salts, and combinations thereof. Sodium bicarbonate compounds of interest include, but are not limited to: nahcolite (NaHCO₃) and amorphous sodium bicarbonate (NaHCO₃), and combinations thereof. Sodium carbonate compounds of interest include, but are not limited to: sodium carbonate decahydrate (Na₂CO₃.10H₂O), thermonatrite (Na₂CO₃.H₂O), sodium carbonate heptahydrate (Na₂CO₃.7H₂O) and sodium carbonate anyhydrate (Na₂CO₃), and combinations thereof.

Precipitation of solid alkali metal salt compositions from bicarbonate rich product, e.g., as described above, results in the production of a composition that includes both precipitated solid alkali metal salt compositions, as well as the remaining liquid from which the precipitated product was produced (i.e., the mother liquor). This composition may be present as a slurry of the precipitate and mother liquor.

Where desired, the resultant precipitated product (i.e., solid alkali metal salt composition) may be separated from the resultant mother liquor. Separation of the solid alkali metal salt composition can be achieved using any convenient approach. For example, separation may be achieved by drying the solid alkali metal salt composition to produce a dried solid alkali metal salt composition. Drying protocols of interest include filtering the precipitate from the mother liquor to produce a filtrate and then air drying the filtrate. Where the filtrate is air dried, air drying may be at a temperature ranging from −70 to 120° C., as desired. In some instances, drying may include placing the slurry at a drying site, such as a tailings pond, and allowing the liquid component of the precipitate to evaporate and leave behind the desired dried product. Also of interest are freeze-drying (i.e., lyophilization) protocols, where the solid alkali metal salt composition is frozen, the surrounding pressure is reduced and enough heat is added to allow the frozen water in the material to sublime directly from the frozen precipitate phase to gas. Yet another drying protocol of interest is spray drying, where the liquid containing the precipitate is dried by feeding it through a hot gas, e.g., where the liquid feed is pumped through an atomizer into a main drying chamber and a hot gas is passed as a co-current or counter-current to the atomizer direction.

Where the precipitated product is separated from the mother liquor, the resultant precipitate may be disposed of in a variety of different ways, as further elaborated below. For example, the precipitate may be employed as an industrial or household use product, as described further below.

In certain embodiments, the product alkali metal carbonate composition is refined (i.e., processed) in some manner prior to subsequent use. Refinement may include a variety of different protocols. In certain embodiments, the product is subjected to mechanical refinement, e.g., grinding, in order to obtain a product with desired physical properties, e.g., particle size, etc.

The above methodology may be carried out using batch or continuous processing protocols, as desired. For example, a batch protocol may be employed where a reactor is configured to contact a bicarbonate rich product with an alkali metal source, and optionally with a CO₂ containing gas, under conditions sufficient to produce an alkali metal carbonate, e.g., by precipitation of the alkali metal carbonate. The alkali metal carbonate product may then be separated from the mother liquor in a separator and further processed to produce a dried alkali metal carbonate product.

In a continuous process, rather than allowing the formation of the alkali metal carbonate to reach completion (i.e., reach equilibrium) in the reactor, a continuous, unidirectional system with a gradient, where upstream, or the front end, is the bicarbonate rich product introduction location, and downstream, or at the rear end, the alkali metal carbonate precipitate forms in suspension, where an alkali metal ion source, and optionally a CO₂ containing gas, is injected in the middle in a continuous punctuated injection process, may be employed.

### Utility

The methods of the invention find use in the production of alkali metal carbonates, e.g., sodium bicarbonate, sodium carbonate, etc., for use in various industrial settings and consumer products. For example, the gas producing properties of sodium bicarbonate find wide use, e.g., as a leavening agent in food preparation, as a source of effervescence in antacid (e.g., U.S. Pat. No. 5,335,760) and detergent formulations (e.g., U.S. Pat. No. 5,578,562), as a fire extinguishing material (e.g., U.S. Pat. Nos. 6,082,464, 5055,208), and as a foaming agent for rubber and plastic (e.g., U.S. Pat. No. 6,635,687). Use of sodium bicarbonate as a fungicide is described in, e.g., U.S. Pat. Nos. 5,415,877 and 5,910,323. Many other uses of sodium bicarbonate are described in, e.g., PCT/GB/2013/050412.

Sodium carbonate finds use in the manufacture of glass (e.g., U.S. Pat. Nos. 5,972,817, 5,215,563), paper (e.g., U.S. Pat. Nos. 4,411,737, 4,155,845), soap and detergents (e.g., U.S. Pat. Nos. 7,828,905, 6,555,513, 4,659,497) and other chemicals.

Also of interest are using the methods of the invention as part of a CO₂ sequestration process to produce useful alkali metal carbonates, as described above, and offset the cost of CO₂ sequestration.

### Systems

Aspects of the invention include bicarbonate containing aqueous medium concentrators and alkali metal carbonate precipitators and systems that include the same. A system is an apparatus that includes a bicarbonate containing aqueous medium concentrator and an alkali metal carbonate precipitator that is operatively coupled to one or more other functional components, e.g., a bicarbonate containing aqueous medium source, etc., as described in greater detail below.

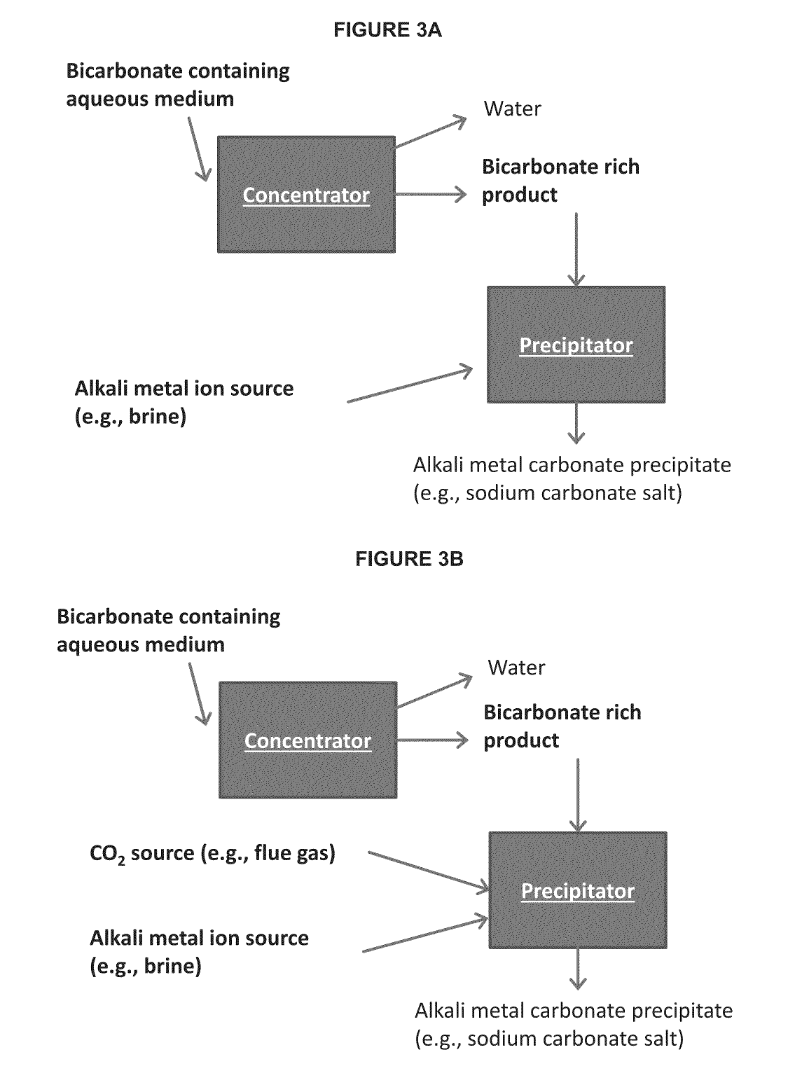

Aspects of the invention further include systems, e.g., small scale devices, processing plants or factories, for concentrating a bicarbonate containing aqueous medium to generate a bicarbonate rich product, and contacting the bicarbonate rich product with an alkali metal ion source, and optionally a CO₂ containing gas, under conditions sufficient to produce an alkali metal carbonate, e.g., by practicing methods as described above, as shown schematically in FIGS. 3A and B. Systems of the invention may have any configuration which enables practice of the particular production method of interest.

The concentrator and precipitator may include any of a number of components, such as temperature regulators (e.g., configured to heat or cool the aqueous medium to a desired temperature), chemical additive components, e.g., for introducing agents that enhance production of alkali metal carbonates, mechanical agitation and physical stirring mechanisms. The concentrator and precipitator may also include components that allow for the monitoring of one or more parameters such as internal reactor pressure, pH, metal-ion concentration, and pCO₂.

Where desired, the precipitator may be operably coupled to a separator configured to separate a precipitated alkali metal carbonate composition from a mother liquor, which are produced from the bicarbonate rich product in the precipitator. In certain embodiments, the separator may achieve separation of a precipitated alkali metal salt composition from a mother liquor by a mechanical approach, e.g., where bulk excess water is drained from the precipitate by gravity or with the addition of a vacuum, mechanical pressing, filtering the precipitate from the mother liquor to produce a filtrate, centrifugation or by gravitational sedimentation of the precipitate and drainage of the mother liquor. The system may also include a washing station where bulk dewatered precipitate from the separator is washed, e.g., to remove salts and other solutes from the precipitate, prior to drying at the drying station. In some instances, the system further includes a drying station for drying the precipitated alkali metal salt composition produced by the alkali metal salt precipitation station. Depending on the particular drying protocol of the system, the drying station may include a filtration element, freeze drying structure, spray drying structure, etc. as described more fully above. The system may include a conveyer, e.g., duct, from the industrial plant that is connected to the dryer so that a gaseous waste stream (i.e., industrial plant flue gas) may be contacted directly with the wet precipitate in the drying stage. In certain embodiments, a gas containing sufficient amounts of carbon dioxide may be used to dry an alkali metal bicarbonate salt, e.g., sodium bicarbonate, as described in U.S. Pat. No. 8,236,268, which is incorporated herein by reference. The resultant dried precipitate may undergo further processing, e.g., grinding, milling, in a refining station, in order to obtain desired physical properties.

The system may further have outlet conveyers, e.g., conveyer belt, slurry pump, that allow for the removal of precipitate from one or more of the following: the precipitator, drying station, washing station or from the refining station. The product of the precipitation reaction may be disposed of in a number of different ways. The precipitate may be transported to a bicarbonate salt of carbonate salt processing or packaging site in empty conveyance vehicles, e.g., barges, train cars, trucks, etc. Any convenient protocol for transporting the composition to the site of disposal may be employed. In certain embodiments, a pipeline or analogous slurry conveyance structure may be employed, where these approaches may include active pumping, gravitational mediated flow, etc.

### Bicarbonate Concentrator

In producing an alkali metal carbonate, e.g., as described above, a bicarbonate containing aqueous medium may be concentrated in a concentrator configured to generate a bicarbonate rich product.

The concentrator conditions are sufficient to generate a bicarbonate rich product from a bicarbonate containing aqueous medium. Where desired, the concentrator may be pressurized. By pressurized is meant the pressure inside the concentrator (or at least the portion thereof that is pressurized) is greater than the atmospheric pressure in the location of the concentrator. As such, in some instances, the bicarbonate containing aqueous medium is concentrated under pressure. While the pressure at the pressurized location of the concentrator may vary, in some instances the pressure is 50 psi or greater, such as 75 psi or greater, including 100 psi or greater, ranging in some instances from 50 to 500 psi, such as 75 to 250 psi. The temperature in the concentrator may vary, and in some instances ranges from 0 to 100° C., such as 20 to 80° C. and including 40 to 70° C. In some instances, the pH of the concentrator ranges from 6 to 10, such as 6.5 to 9.5, including 7 to 9.

Where desired, an anti-scaling agent may be included in the concentrator, e.g., to reduce or inhibit unintentional precipitation in the concentrator and/or piping. Any convenient anti-scaling agent may be employed, where such agents include, but are not limited to: descaling chemicals, e.g., aspartic acid, poly aspartic acid, glutamic acid, poly glutamic acid, acrylic acid, polyacrylic acid, hydrochloric acid or the salts of the above mentioned chemicals i.e., aspartate, etc.

Aspects of the methods include, in some embodiments, generating a bicarbonate rich product from a bicarbonate containing aqueous medium by dewatering. In certain instances, dewatering is accomplished by size-selective ion separation using selective membranes, as described above. Selective membranes may be disposed on any suitable support structure in the concentrator of the subject systems. For example, in some embodiments, a selective membrane may include a layer of material having a desired pore size, as described above, and may be disposed on a support structure, e.g., a macroporous support layer, wherein a solution comprising molecules to be separated by the selective membrane can freely pass through the macroporous support layer. In certain instances, the selective membrane may be shaped to be wound tightly into a spiral configuration. The spiral elements make efficient use of the volume in a concentrator by tightly fitting a large area of membrane into a small space.

In some embodiments, a size-based ion separator may be a physical structure that partitions an interior portion of the concentrator into at least two distinct regions, each region being separated from the other by the size-based ion separator, e.g., the selective membrane. In some embodiments, a size-based ion separator may be disposed on or in a cartridge component that can be installed in a desired position inside the concentrator to partition the concentrator into at least two distinct regions. For example, in some embodiments, a size-based ion separator may be configured to be installed inside a concentrator to partition the interior of the concentrator into at least two distinct regions that are separated by the size-based ion separator.

In some embodiments, a bicarbonate containing aqueous medium may be introduced into a first region of the partitioned concentrator, such that the bicarbonate containing aqueous medium is present on a first side of the size-based ion separator. The size-base ion separator may be used to selectively separate various components of the bicarbonate containing aqueous medium. For example, in some embodiments, non-BRLCP components of the bicarbonate containing aqueous medium, such as water, may be selectively transported through, or across, the size-based ion separator, while BRLCP components may be retained on the first side of the size-based ion separator, as described above.

In some embodiments, a size-based ion separator may be in the form of a tube-like structure having a first end and a second end. The tube-like structure may be placed inside the concentrator such that the first end is fluidly coupled to a port on the first end of the concentrator and the second end is fluidly coupled to a port on the second end of the concentrator. The walls of the tube-like structure may be disposed with a size-based selective ion separator, such as a membrane. The interior region of the tube-like structure is separated from the rest of the interior of the reactor by the walls of the tube-like structure, and forms a filtration chamber. In some embodiments, a bicarbonate containing aqueous medium may be introduced directly into the interior of the tube-like structure, i.e., into the filtration chamber, where it is dewatered to form a bicarbonate rich product.

The walls of the filtration chamber may be disposed with a membrane having a defined pore size. In certain embodiments, a pressure differential is applied across the membrane and the droplets of the BRLCP, e.g., the bidentate entities, have a size that is larger than the pores of the membrane, and therefore cannot pass through the membrane. Entities such as water, in contrast, have a size that is smaller than the pores of the membrane, and therefore freely pass through the membrane. As a result of the pressure differential across the membrane, the concentration of the BRLCP within the filtration chamber is increased. In this way, the bicarbonate containing aqueous medium may be dewatered to generate a bicarbonate rich product.

In certain instances, the concentrator may be configured to receive a bicarbonate containing aqueous medium at a first region of the partitioned concentrator, such that the bicarbonate containing aqueous medium is present on a first side of the size-based ion separator, and a draw liquid at a second region of the partitioned concentrator, such that the draw liquid is present on a second side of the size-based ion separator. As described above, the osmotic potential difference across the membrane between the bicarbonate containing aqueous medium and the draw liquid may generate a net movement of water out of the bicarbonate containing aqueous medium through, or across, the membrane and into the draw liquid, thereby increasing the concentration of BRLCP compositions in the bicarbonate containing aqueous medium.

Concentrators of interest may include a number of additional components, as desired. For example, bicarbonate concentrators may include process control equipment, such as, e.g., temperature control systems, pressure control systems and/or pH control systems that may be used to control various aspects of the alkali metal salt production reaction. For example, in some embodiments, a temperature control system comprising a heating component, such as, e.g., a temperature blanket, a cooling component, such as a heat exchanger, a temperature probe, and a temperature control automation system comprising a temperature controller and a processor may be used to maintain the temperature of the contents of the bicarbonate concentrator within a specified temperature range. For example, in some embodiments, a temperature control system may be used to maintain the contents of the bicarbonate concentrator at a temperature ranging from 35-40° C. In some embodiments, the temperature control system may be used to shift the temperature of the contents of the bicarbonate concentrator from a first temperature to a second temperature. For example, in some embodiments the temperature may be maintained at 35-40° C. for a first period of time, and then shifted to a range of 25-30° C. for a second period of time. In some instances, ion selective electrodes may be included, e.g., to provide the ability to monitor ion concentration changes.

In some embodiments, the concentrator includes a pressurizing component that can be used to pressurize at least a portion of the interior of the concentrator such that the pressurized portion of the concentrator has a pressure that is greater than the pressure of the environment outside the concentrator. The operating pressure range of the concentrator may vary based on, e.g., the desired scale of alkali metal salt production and/or the size of the reactor, and may generally range from about 50 psi, up to about 75 psi, up to about 100 psi, up to about 125 psi, up to about 150 psi, up to about 175 psi, up to about 200 psi, up to about 225 psi, up to about 250 psi, including up to about 500 psi, or more. In some embodiments, the pressure inside the reactor may range from about 5 atm, up to about 6 atm, up to about 7 atm, up to about 8 atm, up to about 9 atm, up to about 10 atm, up to about 11 atm, up to about 12 atm, up to about 13 atm, up to about 14 atm, up to about 15 atm or more.

In some embodiments, a pH control system comprising an acid source and a base source, a pH probe, and a pH control automation system comprising a pH controller and a processor may be used to maintain the pH of the contents of the alkali metal salt production reactor within a specified pH range. For example, in some embodiments, a pH control system may be used to maintain the contents of the bicarbonate concentrator at a pH ranging from 8.0 to 9.0 pH units. In some embodiments, the pH control system may be used to shift the pH of the contents of the bicarbonate concentrator from a first pH value to a second pH value. For example, in some embodiments the pH may be maintained at 8.0 to 9.0 pH units for a first period of time, and then shifted to a range of 9.0 to 10.0 pH units for a second period of time.

The subject concentrator may include at least one elongated structure having a first end and a second end. The elongated structure may be hollow and includes solid walls that define an interior region of the concentrator where the bicarbonate containing aqueous medium is introduced and concentrated. The overall length and width of the structure may vary depending on many different variables, such as, e.g., the desired scale of alkali metal salt production, the amount of bicarbonate containing aqueous medium used, the particular operating conditions to be employed, and the like. In some embodiments, the length of the concentrator ranges from 1 to 200 ft, such as 20 ft to 80 ft and including 27.1 ft to 31.0 ft. The width, e.g., diameter of the concentrator may also vary, and in some embodiments ranges from 1 in. to 120 in., such as 3 in. to 60 in and including 12 in to 24 in. As such, the volume of the concentrator may also vary. In some instances, the total volume of the reactor ranges from 0.02 ft³ to 125 ft³, such as 1 ft³ to 80 ft³ and including 10.9 ft³ to 20.5 ft³.

The cross-sectional shape of the concentrator may vary as well. In some embodiments, the concentrator is generally cylindrical and has a circular cross sectional shape. In other embodiments, a subject concentrator may have other cross-sectional shapes, including, e.g., elliptical, square and/or rectangular cross-sectional shapes.

The subject concentrators are generally constructed from rigid, non-reactive materials that are suitable to contain a bicarbonate containing aqueous medium concentrating process during operation of the concentrator. Examples of suitable materials include, but are not limited to, metals and metal alloys (e.g., stainless steel, low carbon alloy steel), ceramics, glass, polymeric components, and the like. In some embodiments, the subject concentrators may be constructed from composite materials, such as, e.g., fiber-reinforced polymers, metal composites, ceramic composites, and the like.

The subject bicarbonate concentrators may include a first end and a second end. In some embodiments, the first end is configured to receive a bicarbonate containing aqueous medium. Accordingly, in some embodiments the first end may include one or more ports that may be used to fluidly connect one or more sources of a bicarbonate containing aqueous medium to the interior of the concentrator. For example, in some embodiments the first end of the concentrator may include one or more ports that may be coupled to various source containers (e.g., via tubing) comprising a bicarbonate containing aqueous medium.

In use, the ports on the first end of the concentrator may be used to control the introduction of bicarbonate containing aqueous medium into the interior of the concentrator, and therefore may be used to control the overall rate of a concentration process carried out in the concentrator. For example, in some embodiments, the first end of the concentrator may include various control elements (e.g., valves, metering devices and the like) that may be configured to control the amount of the bicarbonate containing aqueous medium that is introduced into the concentrator, or may be used to control the rate of introduction of a bicarbonate containing aqueous medium into the interior of the concentrator. Accordingly, the input rate of each reaction precursor can be controlled at the first end of the concentrator.

The second end of the concentrator may be configured to output a bicarbonate rich product. As such, in certain embodiments the second end of the concentrator may include one or more ports that can be used to remove a bicarbonate rich product from the concentrator. In some embodiments, the second end of the concentrator includes a port that can be used to remove a permeate from the interior of the concentrator.

As described above regarding the first end of the concentrator, the ports on the second end of the concentrator may include, e.g., control elements that may be used to control the removal of a specified amount of a given product from the concentrator, or to control the rate of removal of a given product from the concentrator. In some embodiments, the ports on the second end of the concentrator may be fluidly coupled to, e.g., one or more containers that are configured to hold the products. In certain embodiments, the ports on the second end of the concentrator may be fluidly coupled to a precipitator, as described further below.

In certain embodiments, the bicarbonate containing aqueous medium may be processed before or after being concentrated in the bicarbonate concentrator, for example, to separate components that are undesirable, such as divalent cations, from the BRLCP component, as described above. In certain instances, a bicarbonate concentrator may be operationally coupled to an apparatus configured to separate the BRLCP component from the non-BRLCP components based on electrical charge using, for example, an ion exchange resin. For instance, as the bicarbonate containing aqueous medium or bicarbonate rich product contacts the ion exchange resin disposed in the apparatus, charged ions, such as divalent cations, may be preferentially retained on the resin, while the relatively weakly charged BRLCP components of the bicarbonate containing aqueous medium or bicarbonate rich product may be recovered in the unbound fractions as a bicarbonate containing aqueous medium or bicarbonate rich product with a higher purity of BRLCP components.

### Alkali Metal Carbonate Precipitator

According to aspects of the present methods, an alkali metal carbonate precipitator may be configured to contact a bicarbonate rich product with an alkali metal ion source under conditions sufficient to produce an alkali metal carbonate.

In certain embodiments, the alkali metal carbonate precipitator is configured to receive a bicarbonate rich product through, for example, an inlet port that may be fluidly coupled to a source of bicarbonate rich product. In some embodiments, the source of bicarbonate rich product may be a container configured to hold a bicarbonate rich product. In some instances, the inlet port of the precipitator may be operationally coupled to a bicarbonate concentrator, as described above. In certain embodiments, the precipitator may be operationally coupled to a bicarbonate concentrator such that the precipitator receives a bicarbonate rich product passed from the concentrator.

In some embodiments, the precipitator is configured to promote precipitation of an alkali metal carbonate by, for example, dewatering, depressurizing, cooling, saturating, etc., the bicarbonate rich product that is contacted with an alkali metal ions source, as described above.

In certain embodiments, the precipitator is configured to contact the bicarbonate rich product with an alkali metal ion source to produce an alkali metal carbonate. In certain instances, the precipitator may be equipped with one or more ports to receive the reactants from their respective sources. The input ports of the precipitator through which the bicarbonate rich product and the alkali metal ion source may be introduced may be used to control the introduction of the reactants into the interior of the precipitator, and therefore may be used to control the overall rate of a precipitation process carried out in the precipitator. Contact between the bicarbonate rich product and the alkali metal ion source may be accomplished through use of a static mixer, a rotary mixer, a column, such as a spray column or packed column, loop reactors, and the like.

In certain embodiments, the precipitator conditions (which may vary in a multistage reactor from one stage to the next) are sufficient to produce an alkali metal carbonate composition by contacting the bicarbonate rich product with an alkali metal ion source and a CO₂ containing gas. The CO₂ containing gas may be contacted with the aqueous phase using any convenient protocol, as described above. In certain embodiments, the precipitator may be equipped with one or more ports to receive a CO₂ containing gas from a CO₂ containing gas source. In certain embodiments the precipitator may be configured to contact CO₂ containing gas with a bicarbonate rich product and an alkali metal ion source under conditions sufficient to produce an alkali metal carbonate. Contact may be accomplished through use of infusers, bubblers, fluidic Venturi reactors, spargers, gas filters, sprays, trays, or packed column reactors, and the like, as may be convenient.

The CO₂ containing gas source may vary. Examples of CO₂ containing gas sources include, but are not limited to, pipes, ducts, or conduits which direct the CO₂ containing gas to a portion of the system, e.g., to a precipitator configured to produce an alkali metal carbonate, e.g., from a bicarbonate rich product.

Separate sources of each of the components may be separately fed into an upstream location of the precipitator. Alternatively, two the components may be contacted prior to their introduction into the precipitator. For example, the CO₂ containing gas and alkali metal ion source, if in liquid form, may be contacted prior to their introduction into the precipitator. In other instances, the CO₂ containing gas and alkali metal ion source may be contacted in the precipitator prior to contacting the bicarbonate rich product.

In certain embodiments, the precipitator may be configured to dewater the bicarbonate rich product that is contacted with an alkali metal ion source and/or a CO₂ containing gas. In some embodiments, a membrane-based separator for dewatering in the precipitator may be substantially similar to the membrane-based separator for dewatering in the bicarbonate concentrator, as described above, or in some instances they may be different. For example, a precipitator having a membrane-based separator may employ different conditions, including, but not limited to membrane pore size, membrane type, pressure, temperature, pH and the like, compared to the concentrator to achieve conditions sufficient to precipitate the alkali metal carbonate. In other embodiments, the precipitator may be configured to dewater the bicarbonate rich product by evaporation, such as by vapor-compression evaporation, as described above.

In some embodiments, the precipitator includes a pressurizing component that can be used to regulate the pressure in at least a portion of the interior of the precipitator so as to promote precipitation of an alkali metal carbonate from the bicarbonate rich product that is contacted with an alkali metal ion source and/or a CO₂ containing gas. In certain instances, where the bicarbonate rich product is a pressurized composition, the precipitator may be configured to receive the pressurized bicarbonate rich product and subsequently reduce the pressure in at least a portion of the interior of the precipitator, as described above.

In some embodiments, a temperature control system comprising a heating component, such as, e.g., a temperature blanket, a cooling component, e.g., a heat exchanger, a temperature probe, and a temperature control automation system comprising a temperature controller and a processor may be used to control the temperature of the contents of the alkali metal carbonate precipitator to promote precipitation of the alkali metal salt. For example, in some embodiments, a temperature control system may be used to maintain the contents of the alkali metal carbonate precipitator at a temperature ranging from 35-40° C. In some embodiments, the temperature control system may be used to shift the temperature of the contents of the alkali metal carbonate precipitator from a first temperature to a second temperature. For example, in some embodiments the temperature may be maintained at 35-40° C. for a first period of time, and then shifted to a range of 25-30° C. for a second period of time.

In some embodiments, an alkali metal carbonate precipitator may include a plurality of stages, wherein the individual stages are connected in series and are in fluid communication with each other. In use, a first process can be carried out in the first stage, and one of more products of the first process may be passed to a subsequence stage of the reactor for additional processing. In some embodiments, one or more reaction precursor materials may be introduced at each individual stage that is connected in series. Any suitable combination of processes that promote precipitation of an alkali metal carbonate may be carried out at each individual stage of a multistage precipitator.

In certain embodiments, each of the connected stages may be configured to perform different steps of an alkali metal salt precipitation reaction. For example, in some embodiments, two or more connected stages may have different dimensions, and/or may include different conditions, such as, e.g., different pressures, different pH, etc. In some embodiments, two or more stages that are connected may be identical. For example, a first stage of an alkali metal carbonate precipitator may be configured to depressurize a bicarbonate rich product to promote precipitation of an alkali metal carbonate, and a second stage of an alkali metal carbonate precipitator may be configured to dewater the remaining mother liquor from the first stage to further precipitate an alkali metal carbonate. In certain embodiments, two or more stages may be connected in parallel, and the product of each of the stages may be identical, or one or more of the products from each stage may be different. Any of a variety of suitable combinations of stages may be used to produce a subject alkali metal carbonate from the bicarbonate rich product.

The number of stages that can be connected in series and/or in parallel may range from 2 or more, up to 3 or more, up to 4 or more, up to 5 or more, up to 10 or more, up to 20 or more, up to 30 or more, up to 40 or more, or up to 50 or more.

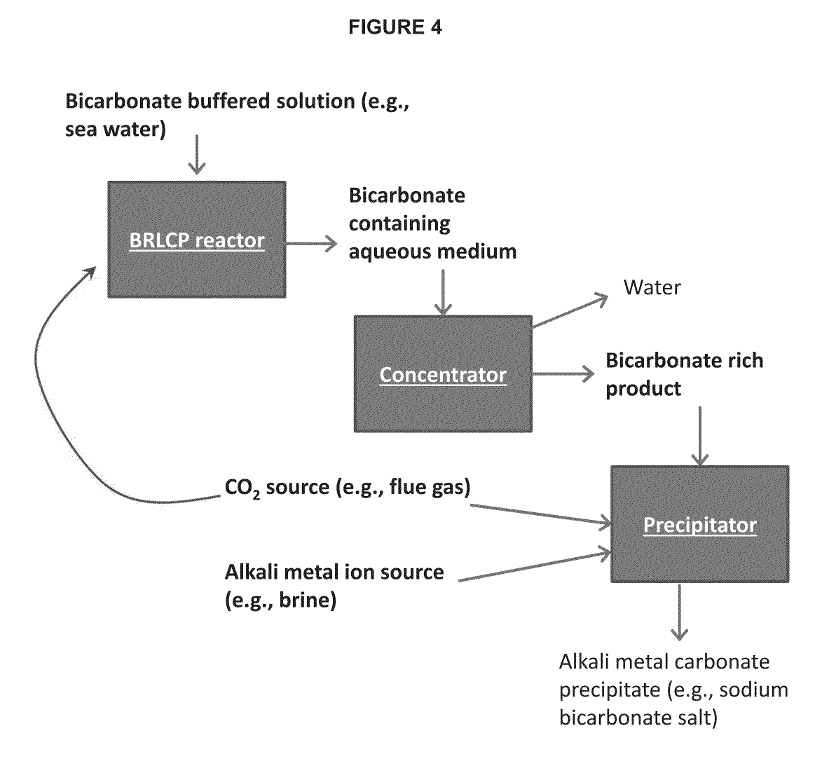

As summarized above, the bicarbonate concentrators and alkali metal carbonate precipitators may be part of a system that includes additional functional components. For example, the bicarbonate concentrators may be operatively coupled to a bicarbonate containing aqueous medium reactor configured to produce a bicarbonate containing aqueous medium from reactants, as shown schematically in FIG. 4. The precipitators may also be coupled to a CO₂ generator, e.g., an industrial plant, such as described above.

Any convenient bicarbonate containing aqueous medium source may be included in the system. For example, a system for producing a bicarbonate rich product in an aqueous medium is described in PCT/US2013/058090, the disclosure of which is herein incorporated by reference. Thus a source of bicarbonate containing aqueous medium may include a reactor that is configured to produce a bicarbonate containing aqueous medium from a bicarbonate buffered aqueous medium and a source of CO₂ containing gas. In certain embodiments, the bicarbonate concentrator may include an input for the bicarbonate containing aqueous medium, as described above. In some instances, where the bicarbonate containing aqueous medium is produced under pressure, the reactor may be configured to receive the bicarbonate containing aqueous medium under substantially the same pressure.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A method of producing an alkali metal carbonate, the method comprising:
concentrating a bicarbonate containing aqueous medium to generate a bicarbonate rich product; and
contacting the bicarbonate rich product with an alkali metal ion source under conditions sufficient to produce an alkali metal carbonate.

2. The method according to claim 1, wherein the alkali metal carbonate comprises sodium carbonate.

3. The method according to claim 1, wherein the alkali metal carbonate comprises sodium bicarbonate.

4. The method according to claim 1, wherein the dissolved inorganic carbon (DIC) of the bicarbonate rich product is higher than the DIC of the bicarbonate containing aqueous medium.

5. The method according to claim 1, wherein the concentrating comprises dewatering the bicarbonate containing aqueous medium.

6. The method according to claim 1, wherein the bicarbonate containing aqueous medium has a pH ranging from 6 to 8.

7. The method according to claim 1, wherein the bicarbonate rich product has a pH ranging from 8 to 10.

8. The method according to claim 1, wherein the alkali metal ion source comprises sodium ions.

9. The method according to claim 1, wherein the bicarbonate containing aqueous medium and the bicarbonate rich product comprise droplets of a liquid condensed phase (LCP) in a bulk liquid.

10. The method according to claim 9, wherein the concentration of bicarbonate ions in the LCP droplets is 10,000 ppm or higher.

11. The method according to claim 10, wherein the method further comprises contacting the bicarbonate rich product with a carbon dioxide (CO₂) containing gas.

12. The method according to claim 11, wherein the CO₂ containing gas is sourced from an industrial plant.

13. The method according to claim 12, wherein the CO₂ containing gas is a flue gas.

14. A system for producing an alkali metal carbonate, the system comprising:
a concentrator configured to concentrate a bicarbonate containing aqueous medium to generate a bicarbonate rich product; and
a precipitator configured to contact the bicarbonate rich product with an alkali metal ion source under conditions sufficient to produce an alkali metal carbonate.

15. The system according to claim 14, wherein the concentrator is configured to dewater the bicarbonate containing aqueous medium.

16. The system according to claim 14, wherein the alkali metal ion source comprises sodium ions.

17. The system according to claim 14, wherein the concentrator comprises a size-based separator.

18. The system according to claim 14, wherein the precipitator is further configured to contact the bicarbonate rich product with a CO₂ containing gas.

19. The system according to claim 18, wherein the source of CO₂ containing gas is an industrial plant.

20. The system according to claim 19, wherein the CO₂ containing gas is a flue gas.
